(19) United States
(12) Patent Application Publication
(10) Pub. No.: US 2007/0261577 A1
(43) Pub. Date: Nov. 15, 2007

(54) Printing roll with dead band helical pattern

(76) Inventor: William J. Burrow, Inman, SC (US)

Correspondence Address: J. BENNETT MULLINAX, LLC, P. O. BOX 26029, GREENVILLE, SC, 29616-1029, US

(21) Appl. No.: 11/411,698

(22) Filed: Apr. 26, 2006

(51) Int. Cl. B41F 31/14

(52) U.S. Cl. 101/348

(57) ABSTRACT

A cylindrical roll, which may be an anilox roll, for receiving a fluid for subsequent transfer is provided. The cylindrical roll includes a body that is configured for rotation about an axis. A transfer zone is on the body and is configured for receiving a fluid for subsequent transfer therefrom. A dead zone is on the body and is adjacent to the transfer zone. The dead zone has a helical pattern that is configured for urging fluid towards the transfer zone during rotation of the body.

### FIELD OF THE INVENTION

The present invention relates generally to printing rolls used in printing machines. More particularly, the present application involves an anilox roll used in a printing machine that has a helical pattern located in the dead band of the anilox roll that acts to prevent ink from leaking through a seal of a doctor blade assembly in operative engagement with the anilox roll.

### BACKGROUND

Printing machines, such as flexographic printing machines, have an anilox roll that is used to supply ink to a flexo printing plate that is mounted onto a print cylinder. The anilox roll has a screen of cells that include elements that may be in the shape of an inverted pyramid or a hexagon. A doctor blade assembly is used to introduce ink into the cells. The flexo printing plate is placed in contact with the anilox roll and receives ink from the cells. Subsequently, a substrate is moved over the inked flexo printing plate in order to have an image imparted thereon.

The doctor blade assembly typically has a locking and a working doctor blade that contact the anilox roll and help define an inking chamber. Movement of the anilox roll with respect to the doctor blade assembly causes the working doctor blade to wipe off excess ink so that the cells of the anilox roll are provided with a desired amount. The ends of the doctor blade assembly are sealed in order to contain ink within the inking chamber. The side seals employed are usually made of a resilient material and are positioned against the surface of the anilox roll to prevent ink from escaping.

The side seals should be selected in order to reliably and permanently seal the inking chamber. Unfortunately, it is sometimes the case that the side seals of the doctor blade assembly fail and allow ink to escape the inking chamber. Escaped ink can then be inadvertently deposited on associated machinery or on the substrate that is being printed. Desirably, the side seals should have a high resistance to abrasion since the side seals are in frictional contact with the rotating anilox roll. If the side seals are not sufficiently resistant to abrasion, the side seals will quickly wear down and their ability to seal the inking chamber will be compromised.

The side seals also come into contact with inks and solvents. In this regard the side seals should be chemically resistant to these materials. Contact with ink and other liquids can lead to swelling and softening of the material that makes up the side seals and could potentially lead to their failure. It is also the case that the material of the side seals may become brittle after the side seal is dried out. Additionally, certain portions of the side seal may not come into contact with ink and other liquids and become brittle over time which could lead to loss of sealing ability.

Designs for preventing leaks by improving sealing at the sides of the doctor blade assembly have been envisioned. In this regard, prior designs include providing one or more intermediate walls positioned proximate to the side seals and spaced inboard therefrom. This type of design seeks to strengthen the overall sealing arrangement by adding additional sealing elements in order to reduce leakage. The intermediate walls create chambers that collect ink that propagates along the working and locking blades of the doctor blade assembly. A drainage port in the chamber is provided for the removal of the collected ink.

Other designs involve modifying the side seal itself. In accordance with one modification, the side seal is made out of two materials. A strip of harder elastic material, for example spring steel, is placed into engagement with the anilox roll while a second softer material makes up the rest of the side seal. The harder elastic material has a higher frictional resistance and hence lasts longer in use. Other designs have been proposed that include modification of the shape and configuration of the side seal. For example, the side seal may be a V-shaped seal with a pair of lips and a pair of auxiliary lips that contact the anilox roll. Although the aforementioned designs work well for their intended purpose, there remains room for variation and improvement within the art.

### SUMMARY

Various features and advantages of the invention will be set forth in part in the following description, or may be obvious from the description, or may be learned from practice of the invention.

One aspect of the present invention provides for a cylindrical roll, in some instances an anilox roll, for receiving a fluid for subsequent transfer. The roll has a transfer zone and at least one dead zone that has a helical pattern. The helical pattern is configured to urge fluid on the dead zone towards the transfer zone during rotation of the roll. Such a configuration helps prevent fluid leakage through a side seal of a doctor blade assembly that may be in engagement with the roll. Additionally or alternatively, the helical pattern may interact with the side seal of the doctor blade assembly in such a way so as to prevent the side seal from drying out and subsequently failing.

In accordance with one exemplary embodiment of the present invention, a cylindrical roll for receiving a fluid for subsequent transfer is provided. The roll has a body that is configured for rotation about an axis. A transfer zone is on the body and is configured for receiving a fluid for subsequent transfer therefrom. A dead zone is also on the body and is adjacent to the transfer zone. The dead zone has a helical pattern that is configured for urging fluid towards the transfer zone during rotation of the body.

An additional aspect of the present invention exists in a cylindrical roll as immediately discussed in which the helical pattern is formed by a groove oriented in a helical manner about the circumference of the dead zone. Additionally, the groove may extend at an angle θ away from the end of the body in the direction opposite to that of the direction of rotation of the body. The end of the body from which the groove extends is on an opposite side of the dead zone from the transfer zone.

The present invention also provides in one exemplary embodiment a cylindrical roll as discussed above that includes a doctor blade assembly. A doctor blade from the doctor blade assembly engages the transfer zone, and a side seal from the doctor blade assembly engages the helical pattern of the dead zone.

An additional aspect of the present invention exists in a cylindrical roll as discussed above in which the helical pattern is oriented so as to be perceived as moving towards the transfer zone during rotation of the body.

Another aspect of the invention resides in a cylindrical roll as previously discussed in which the helical pattern is formed by at least one projection that extends around at least a portion of the circumference of the dead zone.

The present invention also provides for an anilox roll that has a body configured for rotation about an axis. The body has a first end and a second end. A transfer zone is on the body and has a plurality of cells configured for receiving and subsequently transferring a fluid. A dead zone is on the body and has a helical pattern made by a groove oriented in a helical manner about the circumference of the dead zone.

An additional aspect of the present invention resides in an anilox roll as immediately discussed in which the dead zone is located between the first end of the body and the transfer zone. Also in this aspect of the invention, the groove extends at an angle θ away from the first end in the direction opposite to that of the direction of rotation of the body.

Another exemplary embodiment of the present invention includes an anilox roll as previously discussed that has a doctor blade assembly. A doctor blade from the doctor blade assembly engages the transfer zone, and a side seal of the doctor blade assembly engages the helical pattern of the dead zone.

An additional exemplary embodiment exists in an anilox roll as discussed above in which a pair of dead zones are present. One of the dead zones is located between the first end of the body and the transfer zone. Another one of the dead zones is located between the second end of the body and the transfer zone. Each of the dead zones has a helical pattern.

A further aspect of the present invention exists in an anilox roll as discussed above in which the helical pattern is oriented so as to be perceived as moving towards the transfer zone during rotation of the body.

Yet another exemplary embodiment of the present invention is found in an anilox roll as previously discussed in which the groove urges fluid towards the transfer zone during rotation of the body when fluid is on the dead zone.

Another exemplary embodiment of the present invention is found in an anilox roll that has a body configured for rotation about an axis. The body has a first end and a second end. A transfer zone is on the body and has a plurality of cells that are configured for receiving and subsequently transferring a fluid. A pair of dead zones are on the body on either side of the transfer zone so that one of the dead zones is proximate to the first end of the body and the other dead zone is proximate to the second end of the body. Each of the dead zones has a helical pattern made by a groove oriented in a helical manner about the circumference of the dead zones. The grooves circumscribe the dead zones at least two times. The grooves extend at an angle θ away from their respect end of the body in the direction opposite to that of the direction of rotation of the body. Rotation of the body causes each of the helical patterns to be perceived as moving towards the transfer zone.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of a printing system that includes a cylindrical roll such as an anilox roll with a helical pattern, doctor blade assembly, print cylinder, and drum in accordance with one exemplary embodiment of the present invention.

FIG. 2 is a partial cross-sectional view of an anilox roll with a helical pattern and a doctor blade assembly in accordance with one exemplary embodiment of the present invention.

FIG. 3A is a front view of an anilox roll with a helical pattern in accordance with one exemplary embodiment of the present invention.

FIG. 3B is a front view of the anilox roll of FIG. 3A rotated 180° from the position in FIG. 3A along its axis in the direction of arrow A.

FIG. 3C is a front view of the anilox roll of FIG. 3A rotated 270° from the position in FIG. 3A along its axis in the direction of arrow A.

FIG. 4 is a partial front view of an anilox roll that has a helical pattern made of a plurality of projections in accordance with one exemplary embodiment of the present invention.

FIG. 5 is a partial front view of an anilox roll that has a helical pattern and a wear strip indicator in accordance with one exemplary embodiment of the present invention.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to about 7 also includes a limit of up to about 5, up to about 3, and up to about 4.5.

The present invention provides for a cylindrical roll 9, such as an anilox roll 10, that has a helical pattern 12 located in a dead band 24 of the roll. The helical pattern 12 may be used to help prevent a fluid, such as ink, from leaking through a side seal 36 of a doctor blade assembly 28 that is in operable engagement with the anilox roll 10. During rotation of the anilox roll 10, the helical pattern 12 acts to push ink inboard along the anilox roll 10 so that the ink will be urged towards an inking chamber 40 of the doctor blade assembly 28 and resisted from moving across the side seal 36 and out of the doctor blade assembly 28.

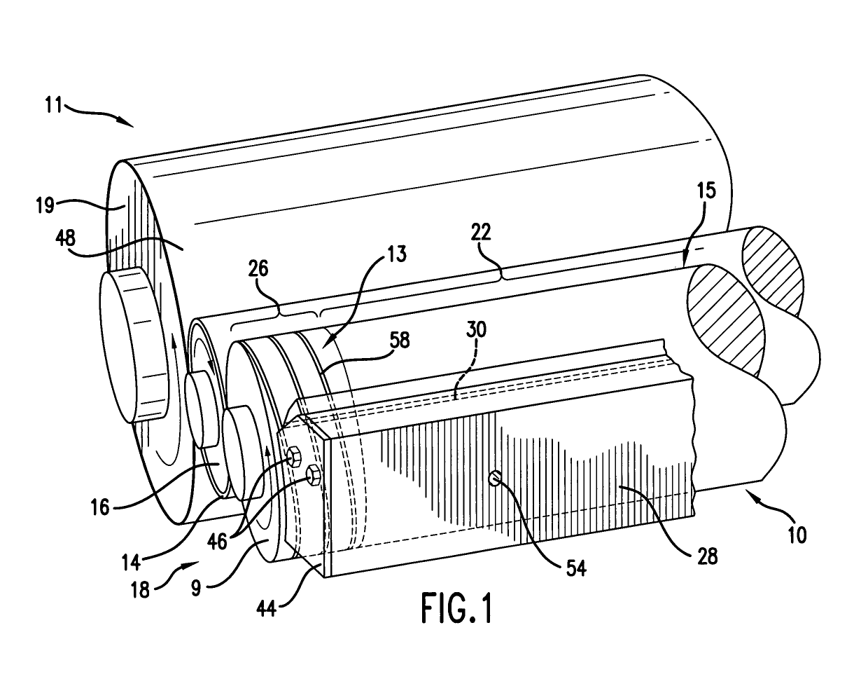

A printing system 11 used to impart an image onto a substrate 48 is shown in FIG. 1. It is to be understood that the printing system 11 illustrated in FIG. 1 is used in order to demonstrate only one embodiment of the present invention and that other configurations are possible. An anilox roll 10 is supplied ink from a doctor blade assembly 28. A print cylinder 16 that carries a flexo printing plate 14 is in rotating engagement with the anilox roll 10 and receives ink therefrom. A drum 19 carries the substrate 48 and is positioned with respect to the print cylinder 16 so that the inked flexo printing plate 14 is placed into engagement with the substrate 48 in order to impart an image thereon.

It is to be understood that other colorants besides ink may be used in the printing system 11 in order to impart an image onto the substrate 48. Further, the printing system 11 may be set up so that an image per se is not placed onto the substrate 48. In this regard, a fluid such as a protective, adhesive, or decorative coating may be placed onto the substrate 48 by the printing system 11. However, for sake of example the present application describes a printing system 11 that applies an inked image onto substrate 48. Again, it is to be understood that the printing system 11 may be used to apply a variety of fluids to a variety of substrates 48. In this regard, although described as employing an anilox roll 10, it is to be understood that other types of cylindrical rolls 9 may be used in place of an anilox roll 10 in accordance with various exemplary embodiments of the present invention.

The anilox roll 10 is made of a body 15, a transfer zone 22, and at least one dead band 24, although a second dead band 26 may be present. The transfer zone 22 and dead bands 24 and/or 26 may be located on the body 15 such that these portions are integral with the body and merely signify different locations or different functional portions on the anilox roll 10. Alternatively, these portions may be separately formed members that are formed or located onto the body 15. The anilox roll 10, in the transfer zone 22, has an outer surface engraved with an array of closely spaced shallow depressions referred to as cells 20. The cells 20 may include elements that are configured in the shape of an inverted pyramid. Additionally, other numerous geometries such as trihelical, pyramidial, quadrangular, hexagonal, circular or square may be used. The volumetric capacity of the surface of the anilox roll 10 is generally dependent upon the size, shape, and number of cells 20 per unit area. The pattern of cells 20 may be very fine so that a large number of cells 20 per square inch are present, or the cell 20 pattern may be coarse so that fewer larger cells 20 are present per square inch. The selection of various cell 20 patterns is dependent upon the particular application in question. The surface of the anilox roll 10 is normally made of a hard ceramic coating in order to resist wear. The cells 20 may be formed in the surface of the anilox roll 10 through the use of laser engraving, although other forms of engraving or formation are possible.

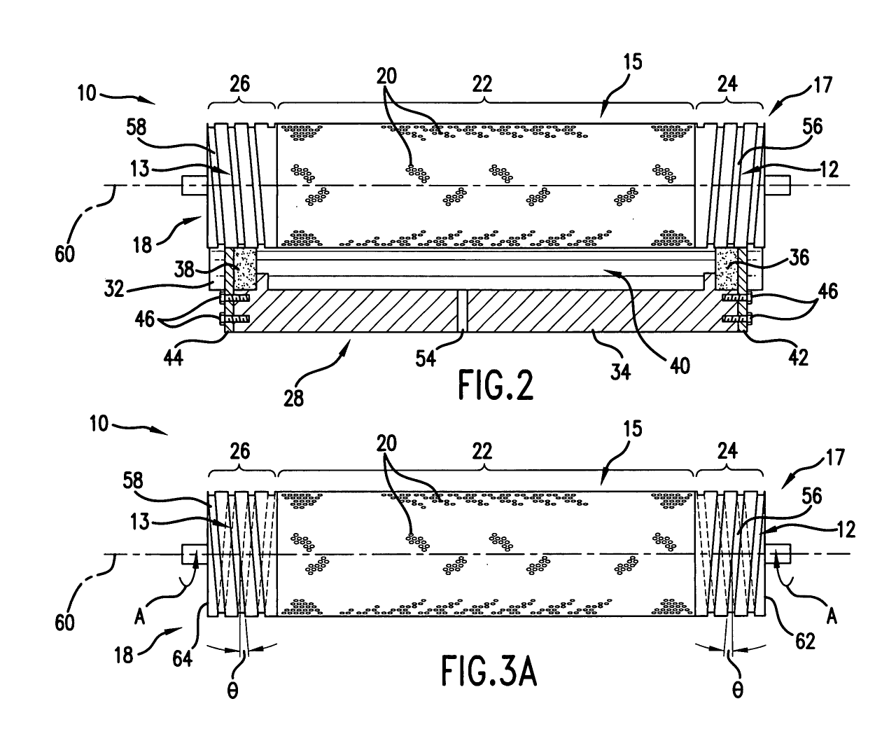

Ink is applied to the cells 20 of the anilox roll 10 by way of a doctor blade assembly 28. As shown in better detail in FIG. 2, the doctor blade assembly 28 has a frame 34 that has a port 54 through which ink can be supplied into an inking chamber 40. The inking chamber 40 is further defined by a locking doctor blade 30 and a working doctor blade 32. The locking doctor blade 30 primarily provides a sealing function to the inking chamber 40. Rotation of the anilox roll 10 causes excess ink on the portion of the anilox roll 10 in the inking chamber 40 to be wiped off by the working doctor blade 32 so that only a certain amount of ink remains in the cells 20. This amount of ink is then transferred to the flexo printing plate 14 of the print cylinder 16. The doctor blades 30 and 32 may be arranged in any manner commonly known in the art. For example, the doctor blades 30 and 32 may be provided as those set forth in U.S. Pat. No. 6,786,153, the entire contents of which are incorporated by reference herein in their entirety for all purposes.

A pair of side seals 36 and 38 are provided in the doctor blade assembly 28 and are used to seal the ends of the inking chamber 40. The side seals 36 and 38 may be made of a resilient material such as rubber. In accordance with various exemplary embodiments, the side seals 36 and 38 may be made of polyethylene or polytetrafluoroethylene. The side seals 36 and 38 may have a Shore A hardness of 60-90 and may preferably have a Shore A hardness of 80 in accordance with certain embodiments. The side seals 36 and 38 typically have a contoured surface that mates with a portion of the outer surface of the anilox roll 10.

As shown, the side seals 36 and 38 press against the anilox roll 10 and prevent ink from moving out of the inking chamber 40 by going between the side seals 36 and 38 and the surface of the anilox roll 10. Side seal 36 is positioned within a recess of the frame 34 and is secured thereon by a clamping plate 42. Likewise, clamping plate 44 is used to hold side seal 38 onto the frame 34 at an end opposite that of side seal 36. Bolts 46 are used to hold the clamping plates 42 and 44 to the frame 34. The side seals 36 and 38 may be configured in a variety of manners and arranged with the frame 34 in a number of ways. For example, the side seals 36 and 38 may be configured as those set forth in U.S. Pat. Nos. 6,016,748 or 6,832,551, the entire contents of which are incorporated by reference herein in their entirety for all purposes.

The cells 20 of the anilox roll 10 are located in the transfer zone 22 of the anilox roll 10. The transfer zone 22 signifies the portion of the outer surface of the anilox roll 10 that is used to transfer ink from the anilox roll 10 to the flexo printing plate 14 or other member. Dead bands 24 and 26 are present on either side of the transfer zone 22. The dead bands 24 and 26 signify portions of the outer surface of the anilox roll 10 that are not used for ink transfer. Dead band 24 is located between a first end 17 of the body 15 and the transfer zone 22. Dead band 26 is located between a second end 18 of the body 15 and the transfer zone 22. It is to be understood that the ends 17 and 18 of the body 15 may be coincident with a portion of the dead bands 24 and 26 such that the dead bands 24 and 26 are still between their respective ends 17 and 18 and the transfer zone 22.

Typically, most anilox rolls 10 have a pair of dead bands 24 and 26. However, it may be the case that in some exemplary embodiments of the present invention that only a single dead band 24 or 26 is present. The dead bands 24 and 26 are typically engaged by the doctor blades 30 and 32 so that the doctor blades 30 and 32 contact and subsequently wear the dead bands 24 and 26 during use. However, it is to be understood that in other exemplary embodiments the doctor blades 30 and/or 32 do not engage the dead bands 24 and 26.

The dead band 24 includes a helical pattern 12 that may be made of a groove 56 that is arranged in a helical manner in the surface of the anilox roll 10. An additional helical pattern 13 may be provided on the opposite end of the anilox roll 10 in dead band 26. The helical pattern 13 may be formed by a groove 58 that is arranged in a helical manner about the anilox roll 10. Any suitable method of forming the grooves 56 and 58 into the anilox roll 10 may be employed. For example, the grooves 56 and 58 may be formed by etching or may be laser engraved in accordance with various exemplary embodiments. The grooves 56 and 58 may be angled the same degree as one another but in opposite directions with respect to an axis 60 of the anilox roll 10.

The width and depth of grooves 56 and 58 may be different in accordance with different exemplary embodiments of the present invention. For example, the width of grooves 56 and 58 may be from 8 mm to 70 mm, and the depth of grooves 56 and 58 may be from 0.5 mm to 15 mm in accordance with various exemplary embodiments. Further, the width and depth of grooves 56 and 58 need not be constant along their entire length but may be varied once or multiple times. Additionally, the width and depth of groove 56 may be different than those of groove 58. Further, although shown as having a constant rectangular cross-section, the cross-sectional shape of grooves 56 and 58 may be any desired shape and may vary along the length of the grooves 56 and 58. Aside from having a rectangular cross-section, the grooves 56 and 58 may be square, triangular, semi-circular, or generally circular in accordance with other exemplary embodiments.

The bottom and/or side surfaces of the grooves 56 and 58 may be smooth. Alternatively, the grooves 56 and 58 may be formed as a series of closely spaced voids so that the grooves 56 and 58 have some degree of texture associated therewith. The grooves 56 and 58 may also be formed in the same manner and may have features similar to the cells 20 that are present in the transfer zone 22 of the anilox roll 10.

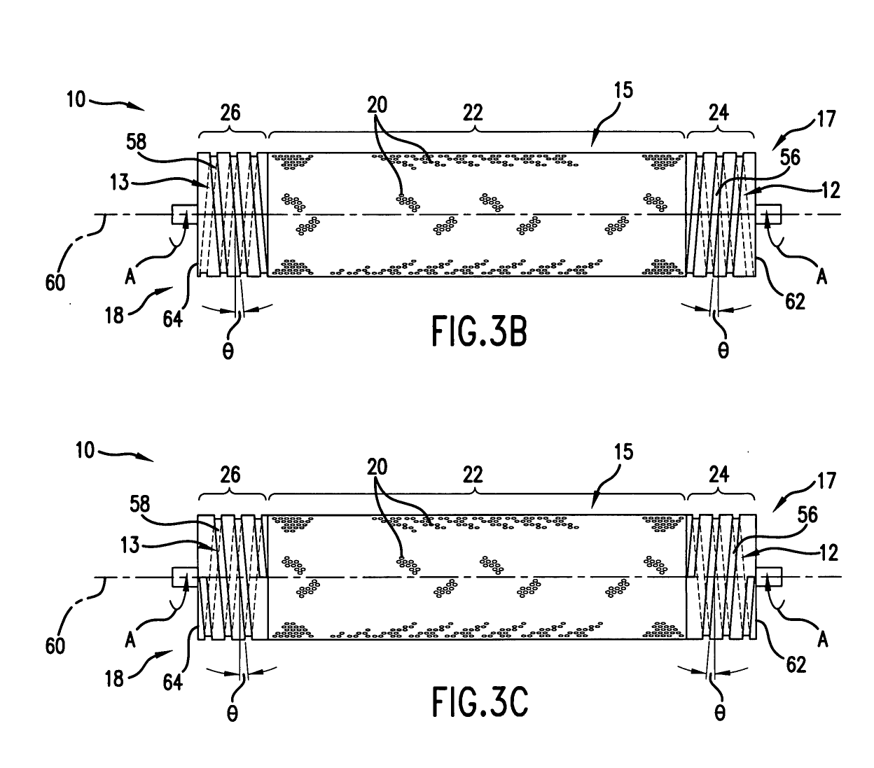

FIGS. 3A-3C show one exemplary embodiment of an anilox roll 10 having helical patterns 12 and 13. FIG. 3A shows the anilox roll 10 situated at a point of 0° degrees of rotation. FIG. 3B shows the anilox roll 10 rotated 180° from the point shown in FIG. 3A. Here, the relative change in the visual positions of the grooves 56 and 58 of the helical patterns 12 and 13 can be noted. The direction of rotation of the anilox roll 10 about axis 60 is denoted by arrow A. FIG. 3C shows the anilox roll 10 rotated an additional 90° from the position of FIG. 3B and consequently rotated 270° from the starting position shown in FIG. 3A. Additional rotation of the anilox roll 10 by 90° from the position of FIG. 3C results in the visual position of the grooves 56 and 58 being that of FIG. 3A.

Rotation of the anilox roll 10 in the direction indicated by arrow A in FIGS. 3A-3C results in the visual perception of inboard movement along the axis 60 of the helical patterns 12 and 13. In this regard, the groove 56 appears to the observer to move inboard along the axis 60. Likewise, the groove 58 appears to also move inboard along the axis 60 by an observer of the rotating anilox roll 10. Perceptible inboard movement of the helical patterns 12 and 13 may be noted upon comparing FIGS. 3A-3C. Perceptible inboard movement of the helical patterns 12 and 13 may act to push ink inboard along the axis 60 of the anilox roll 10 to help prevent ink leakage from the inking chamber 40 through the side seals 36 and 38.

Referring to FIG. 3A, the groove 56 begins proximate to an end 62 of the anilox roll 10. From this starting point, the groove 56 extends at an angle θ away from the end 62 of the anilox roll 10 in the direction opposite to that of the direction of rotation of the anilox roll 10 as noted by Arrow A. Although shown as starting essentially on the end 62, it is to be understood that in other exemplary embodiments that the groove 56 may start at some location inboard of the end 62 and may be oriented in the same manner as that in FIG. 3A. Groove 58 is also shown as starting at a point on the end 64 of the anilox roll 10 and extending at an angle θ away from the end 64 in the direction opposite to that of the direction of rotation of anilox roll 10 again noted by Arrow A. As with groove 56, groove 58 may also begin at some distance away from the end 64 in other exemplary embodiments while having an orientation with respect to the anilox roll 10 that is the same as or similar to that of the embodiment in FIG. 3A.

Although not wishing to be bound by any particular theory of operation, Applicant believes that perceptible inboard movement of the grooves 56 and 58 and/or the portions of the dead bands 24 and 26 proximate to the grooves 56 and 58 acts to urge ink inboard along axis 60. This inboard movement may act to prevent ink from leaking through the side seals 36 and 38. Additionally or alternatively, rotation of the grooves 56 and 58 against the side seals 36 and 38 may also act to keep the side seals 36 and 38 moist by pushing ink against or across the side seals 36 and 38. By keeping the side seals 36 and 38 moist, it may be the case that the side seals 36 and 38 will not dry out and subsequently fail.

The grooves 56 and 58 are angled at an angle θ with respect to a line extending perpendicular to the axis 60 as shown in FIGS. 3A-3C. The angle θ may be from 1° to 10°, from 10° to 20°, or up to 60° in certain exemplary embodiments. In accordance with one exemplary embodiment, the angle θ is 5°. Although shown as constant throughout the entire lengths of the grooves 56 and 58, the angle θ may be varied one or multiple times throughout the length of the grooves 56 and 58 in other exemplary embodiments. Further, the angle θ of groove 56 may be different than the angle θ of groove 58.

The grooves 56 and 58 may extend across any portion of the axial 60 length of the dead bands 24 and 26. Further, the grooves 56 and 58 may circumscribe the outer circumference of the surface of the anilox roll 10 any number of times. Although shown as circumscribing anilox roll 10 three times in FIGS. 3A-3C, it is to be understood that the grooves 56 and 58 may circumscribe the anilox roll once, twice, four times, or up to ten times in various exemplary embodiments. The grooves 56 and 58 may be continuous in that they are not interrupted at any point along the axial direction 60 of the helical patterns 12 and 13. However, other embodiments exist in which the grooves 56 and 58 are not continuous thus causing the grooves 56 and 58 to be made of two or more segments.

Additionally, it is to be understood that each of the helical patterns 12 and 13 are not necessary in other embodiments. In this regard, groove 56 may be included in order to make up helical pattern 12 while the groove 58 is not present thus providing dead band 26 with a smooth outer surface. Alternatively, groove 56 need not be present while dead band 26 includes groove 58 that forms helical pattern 13. As such, only one side of anilox roll 10 may be provided with a helical pattern 12 or 13 in accordance different exemplary embodiments.

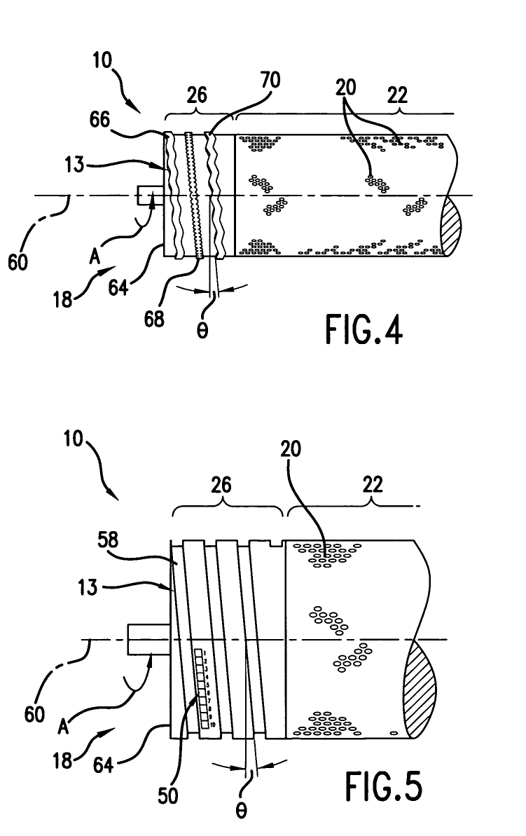

An alternative exemplary embodiment of the anilox roll 10 is shown in FIG. 4. Here, the helical pattern 12 is not formed by groove 56 but is instead formed by three projections or raised sections 66, 68 and 70 that are present on the surface of the anilox roll 10 in the dead band 24. The three sections 66, 68 and 70 are not continuous around the circumference of the anilox roll 10 but are instead located on one side thereof. The three sections 66, 68 and 70 are oriented so that the length of each section from its respective starting point, being the point closest to the end 62, extends away from the end 62 in the direction opposite to the direction of rotation of the anilox roll 10. The orientation of the sections 66, 68 and 70 during rotation of the anilox roll 10 in the direction of arrow A results in a perceptible inboard movement of the sections 66, 68 and 70 along the axis 60.

The first section 66 has a curved shape and is a continuous member that extends across 180° of the surface of the anilox roll 10. The second and third sections 68 and 70 likewise extend across 180° of the surface of the anilox roll 10 although the sections 66, 68 and 70 may extend from 90° to 270°, or up to 200° in accordance with other exemplary embodiments. The second section 68 is composed of a plurality of circular projections that contact one another and form a chain like member. The third section 70 is a continuous member that is formed in a zigzag pattern. The sections 66, 68 and 70 act to force ink inboard along axis 60 so as to prevent leakage from the inking chamber 40. Additionally or alternatively, the sections 66, 68 and 70 may function to keep side seal 36 moist through movement across the side seal 36 in order to prevent the side seal 36 from drying out and subsequently failing.

Although not show in FIG. 4, it is to be understood that the opposite side of the anilox roll 10 may have sections similar to those of sections 66, 68 and 70 in other embodiments. Here, the sections are located in dead band 26 and are oriented in a manner so as to be viewed as moving inboard during rotation of anilox roll 10. It is to be understood that the number, shape, length, and orientation of the sections 66, 68 and 70 may be varied in accordance with various exemplary embodiments. Further, grooves 56 or 58 may be incorporated into the anilox roll 10 along with the sections 66, 68 and 70 in other exemplary embodiments.

FIG. 5 shows an alternative exemplary embodiment of an anilox roll 10 in accordance with the present invention. Here, the dead band 24 is again provided with a groove 56 to form helical pattern 12. Also included in this exemplary embodiment is a wear strip indicator 50 that is located on the dead band 24 between two successive turns of the groove 56. The wear strip indicator 50 has portions that are formed at different depths into the anilox roll 10 and are so identified by a depletion scale indicia. The wear strip indicator 50 is in contact with the doctor blades 30 and 32 and wears down over time through contact. A user of anilox roll 10 may determine the amount of wear by reading the depletion scale indicia. Examples of wear strip indicators 50 that may be used in accordance with certain exemplary embodiments of the present invention are found in aforementioned and incorporated U.S. Pat. No. 6,786,153.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. An anilox roll, comprising:
a body configured for rotation about an axis, said body having a first end and a second end;
a transfer zone on said body, said transfer zone having a plurality of cells configured for receiving and subsequently transferring a fluid; and
a dead zone on said body, said dead zone having a helical pattern made by a groove oriented in a helical manner about the circumference of said dead zone.

2. The anilox roll as in claim 1, wherein said dead zone is located between said first end of said body and said transfer zone, and wherein said groove extends at an angle θ away from said first end in the direction opposite to that of the direction of rotation of said body.

3. The anilox roll as in claim 2, wherein said angle θ is from 1° to 10°.

4. The anilox roll as in claim 1, further comprising a doctor blade assembly, and wherein a doctor blade from said doctor blade assembly engages said transfer zone, and wherein a side seal from said doctor blade assembly engages said helical pattern of said dead zone.

5. The anilox roll as in claim 1, wherein a pair of said dead zones are present in which one of said dead zones is located between said first end of said body and said transfer zone, and wherein the other of said dead zones is located between said second end of said body and said transfer zone, and wherein each of said dead zones has a helical pattern.

6. The anilox roll as in claim 1, wherein said helical pattern is oriented so as to be perceived as moving towards said transfer zone during rotation of said body.

7. The anilox roll as in claim 1, wherein said dead zone has a wear indicator, wherein wear of said wear indicator indicates the degree of wear of said cells of said transfer zone.

8. The anilox roll as in claim 1, wherein said groove urges fluid towards said transfer zone during rotation of said body when fluid is present on said dead zone.

9. The anilox roll as in claim 1, wherein said groove extends from said first end of said body and circumscribes said dead zone at least two times.

10. A cylindrical roll for receiving a fluid for subsequent transfer, comprising:
a body configured for rotation about an axis;
a transfer zone on said body, said transfer zone configured for receiving a fluid for subsequent transfer therefrom; and
a dead zone on said body adjacent to said transfer zone, said dead zone having a helical pattern, said helical pattern configured for urging fluid towards said transfer zone during rotation of said body.

11. The cylindrical roll as in claim 10, wherein said helical pattern is formed by a groove oriented in a helical manner about the circumference of said dead zone.

12. The cylindrical roll as in claim 11, wherein said groove extends at an angle θ away from the end of said body in the direction opposite to that of the direction of rotation of said body, and wherein the end of said body from which said groove extends is on an opposite side of said dead zone from said transfer zone.

13. The cylindrical roll as in claim 12, wherein said angle θ is from 1° to 10°.

14. The cylindrical roll as in claim 10, further comprising a doctor blade assembly, and wherein a doctor blade from said doctor blade assembly engages said transfer zone, and wherein a side seal from said doctor blade assembly engages said helical pattern of said dead zone.

15. The cylindrical roll as in claim 10, wherein a pair of dead zones are on said body on opposite sides of said transfer zone, and wherein each of said dead zones has a helical pattern configured for urging fluid towards said transfer zone during rotation of said body.

16. The cylindrical roll as in claim 10, wherein said helical pattern is oriented so as to be perceived as moving towards said transfer zone during rotation of said body.

17. The cylindrical roll as in claim 10, wherein said dead zone has a wear indicator, wherein wear of said wear indicator indicates the degree of wear of said transfer zone.

18. The cylindrical roll as in claim 10, wherein said helical pattern is formed by at least one projection that extend around at least a portion of the circumference of said dead zone.

19. The cylindrical roll as in claim 10, further comprising a print cylinder having a flexo printing plate in engagement with said transfer zone, and wherein said transfer zone has a plurality of cells configured for receiving ink and transferring ink to said flexo printing plate.

20. An anilox roll, comprising:
a body configured for rotation about an axis, said body having a first end and a second end;
a transfer zone on said body, said transfer zone having a plurality of cells configured for receiving and subsequently transferring a fluid; and
a pair of dead zones on said body on either side of said transfer zone such that one of said dead zone is proximate to said first end of said body and such that the other one of said dead zone is proximate to said second end of said body, wherein each of said dead zones has a helical pattern made by a groove oriented in a helical manner about the circumference of said dead zones, wherein said grooves circumscribe said dead zones at least two times;
wherein said groove of said dead zone proximate to said first end extends at an angle θ away from said first end in the direction opposite to that of the direction of rotation of said body;
wherein said groove of said dead zone proximate to said second end extends at an angle θ away from said second end in the direction opposite to that of the direction of rotation of said body;
wherein rotation of said body causes each of said helical patterns to be perceived as moving towards said transfer zone.
